(19) United States
(12) Patent Application Publication
(10) Pub. No.: US 2013/0312871 A1
(43) Pub. Date: Nov. 28, 2013

(54) REFUELING PLATFORM FOR FILLING A VEHICLE TANK WITH LIQUID HYDROGEN

(71) Applicant: Airbus Operations GmbH, Hamburg (DE)

(72) Inventors: Claus HOFFJANN, Hamburg (DE); Sebastian ALTMANN, Hamburg (DE)

(21) Appl. No.: 13/902,198

(22) Filed: May 24, 2013

Related U.S. Application Data
(60) Provisional application No. 61/651,735, filed on May 25, 2012.

(30) Foreign Application Priority Data
May 25, 2012 (DE) 10 2012 104 546.1

(51) Int. Cl. F17C 5/06

(52) U.S. Cl. CPC F17C 5/06
USPC 141/69; 141/284

(57) ABSTRACT

A refueling platform for filling a vehicle tank with liquid hydrogen comprises a base, a lifting device arranged on the base, a support device arranged on the base, which support device is liftable by way of the lifting device, a cryogenic hydrogen filling tank arranged on the support device, and a conveying device. The conveying device is connectable to a filler hose that is adapted for connecting to a vehicle tank. With said refueling platform a vehicle tank can be replenished that cannot be accessed at ground level, for example a hydrogen tank for operating a fuel cell, which hydrogen tank is arranged in the tail section of an aircraft.

### CROSS-REFERENCE TO RELATED APPLICATIONS

This application claims priority to German Patent Application No. DE 10 2012 104 546.1, filed May 25, 2012, and to U.S. Provisional Patent Application No. 61/651,735, filed May 25, 2012, which are each incorporated herein by reference in their entirety.

### TECHNICAL FIELD

The technical field relates to a refueling platform for refueling a vehicle with liquid hydrogen.

### BACKGROUND

The use of fuel cells for generating electrical energy has great potential for reducing the fuel consumption in vehicles. For operating fuel cells it is possible either to use a hydrocarbon-based fuel that is converted, by reforming, to a hydrogen-containing gas, or to use pure hydrogen from a pressure vessel or from a cryogenic container. For use in larger vehicles, for example commercial aircraft, for reasons relating to space and weight it makes sense, in particular, to provide a cryogenic hydrogen tank in a non-pressurized region of the vehicle fuselage, for example in the region of a tail cone or above a pressurized cabin.

At present it is known to use stationary cryogenic filling stations for filling vehicle tanks. Because of the position of cryogenic tanks for hydrogen on or in a vehicle fuselage, ground-level access to a filler neck of the tank is not possible. Furthermore, when using cryogenic hydrogen, as a result of unavoidable heat input during the flow of liquid hydrogen through a refueling line the density of the hydrogen decreases, thus rendering refueling from a position underneath the aircraft more difficult. Furthermore, in this process gaseous hydrogen may be trapped in the vehicle tank, which on the one hand may increase the pressure in the tank, and on the other hand may result in a reduction in the usable tank volume.

In addition, other objects, desirable features and characteristics will become apparent from the subsequent summary and detailed description, and the appended claims, taken in conjunction with the accompanying drawings and this background.

### SUMMARY

According to various embodiments, provided is a device that allows reliable, simple and safe filling of liquid hydrogen into a vehicle tank that is not located at ground level, for example in an aircraft fuselage.

Such a refueling platform comprises a base, a lifting device arranged on the base, and a support device that is liftable on the base by way of the lifting device. On the support device a cryogenic hydrogen filling tank is arranged that by way of a conveying device is connectable to a filler hose that is adapted for connecting to a vehicle tank and in particular to a filler neck or a coupling of a vehicle tank.

The term “base” refers to any device situated on a ground and providing an initial position or a support for the lifting device. The use of a support device that is arranged on the base by way of the lifting device makes it possible to fill a vehicle tank that is situated considerably higher up than the base. In this arrangement the lifting device may be dimensioned in such a manner that regularly all the presently known or expected geometric heights of filler necks of vehicle tanks are accessible or may be exceeded by the support device so that at all times a filler neck arranged laterally or at the top of the vehicle tank can be connected to the end of the filler hose. In one example, the implementable height of the lifting device is selected in such a manner that an outlet or a bottom delimitation of the hydrogen filling tank on the carrier may move to a position above the filler neck of each vehicle tank.

The hydrogen, which during the refueling process is practically inevitably subjected to heat input, in the filler hose thus need not be conveyed against the force of gravity. As a result of the possibility of lifting the support device from the base, furthermore a much shorter filler hose may be used, when compared to refueling from a lower position, which ultimately results in significantly reduced heat input and thus in a smaller quantity of gaseous hydrogen arising.

In one embodiment, the support device comprises a workplace large enough to accommodate a person so that said person is able to operate the lifting device and to connect a coupling, a flange or some other devices on the end of the filler hose to a filler neck or to a coupling of the vehicle tank. In addition, the workplace makes it possible to monitor the refueling platform and in particular a conveying device for the hydrogen or for the filler hose. The person on the support device is in an optimum position for controlling the basic functions of the refueling platform, and consequently no further personnel are required at some other location.

Conveying liquid hydrogen from the hydrogen filling tank, mounted on the support device, to the vehicle tank requires a conveying device. In the state of the art there are pumps that are suitable for conveying liquid hydrogen essentially without a phase conversion. As an alternative, a conveying device may also comprise a means for generating overpressure that may be introduced into the hydrogen tank. For this purpose, in order to prevent an explosion, an inert gas or gaseous hydrogen may be used that is fed above the fill level into the hydrogen filling tank. If gaseous hydrogen is considered for providing overpressure, said overpressure may be achieved by means of an evaporator that evaporates a defined quantity of liquid hydrogen directly within the hydrogen filling tank so that, for example, an overpressure of about 2 to about 5 bar results. Said evaporator can be designed so as to be separate of the fill tank or it may be integrated therein.

The conveying device should generally comprise a shut-off valve that may interrupt or establish the connection between the hydrogen tank and the filler hose. In addition, the shut-off valve may be connected to at least one safety device explained below, which safety device thus immediately upon a malfunction occurring during the refueling process stops the flow of hydrogen into the vehicle tank.

The hydrogen filler hose is a flexible line that makes possible the individual positioning of an outflow end. The material of this line may be varied, wherein particularly good thermal insulation is important. Since liquid hydrogen has a very low temperature, the flexibility, if as a result of the low temperature it is not achieved as a result of the characteristics of the hose material itself, may also be implemented by connecting several filler hose elements or filler hose sections in an articulated manner.

For example, the filler hose may be designed as a vacuum-insulated hose. The vacuum-insulated hose may, for example, be designed in the form of a flexible corrugated hose made from a metallic material, which corrugated hose is enclosed by vacuum insulation. In this manner it is possible to achieve not only adequate movability of the hose end but also, due to the vacuum insulation, adequate protection against injury to a user as a result of the extremely low temperature of the liquid hydrogen. In this context a coupling arranged on the end of the filler hose may also be designed in the form of a vacuum-insulated pipe section that may concentrically be inserted into a correspondingly-shaped pipe section and may be locked thereto. Locking may take place by way of a screw flange.

Furthermore, it is advantageous to equip the conveying device of the refueling platform with a means for purging the filler hose in order to, prior to refueling, remove air and any condensed water that may be present in the filler hose. Said condensed water could collect in the filler hose after completion of the refueling process as a result of the cold wall of the filler hose. The purging process may take place by means of gaseous hydrogen, wherein during purging said gaseous hydrogen may issue from the free end of the filler hose into the surroundings. As an alternative to this, purging by means of a gas, such as an inert gas or noble gas, would be imaginable, which gas is provided separately in the platform, for example in pressure vessels.

The advantages of the refueling platform according to the present disclosure are due, in particular, to the low-loss refueling of the aircraft with liquid hydrogen as a result of the short hose lengths that are necessary and of the fixed hose connections or pipe connections, as a result of which the arising evaporation losses are low. The ability to individually lift the support device allows the flexible refueling of hydrogen tanks for many different aircraft types and different system configurations that result in different geometric heights of filler necks of vehicle tanks. Furthermore, by further using liquid hydrogen or removed gaseous hydrogen in an accompanying fuel cell and corresponding electrical motors or an internal combustion engine suitable for hydrogen, emission-free operation of the entire refueling platform may take place, which additionally reduces maintenance requirements and the occurrence of ignition sources. Here, too, the use of hybrid technology with batteries is possible.

The refueling platform further comprises a device for removing gaseous hydrogen, which device is connectable to a discharge line. During the conveyance of liquid hydrogen into the vehicle tank, the arising gas pressure may reach a level that for the discharge of the gaseous hydrogen without active conveying means through a pure connection of a discharge line with a free volume, filled by gaseous hydrogen, of the vehicle tank is sufficient. If storage of the gaseous hydrogen is desired, it must be assumed that a higher pressure level is necessary, which level may be achieved by additional devices. The discharge device for the discharge of gaseous hydrogen may, furthermore, be designed as a suction removal device that actively removes hydrogen gas from the vehicle by suction.

The discharge line may, furthermore, be implemented in the form of the filler hose, for example by a concentric arrangement of a filler hose and an additional discharge line with a larger diameter in order to form an annular gap to the filler hose, which gap in addition has an insulating effect on the conveyed liquid hydrogen. As an alternative to the above, a separate coupling or a separate discharge connection in the region of one end of the filler hose is also imaginable, wherein said coupling or discharge connection makes it possible to accommodate a discharge hose or a suction removal line that is separate of the filler hose.

Generally-speaking it cannot be excluded for the discharge of gaseous hydrogen to be possible also after completion of a short refueling process; nevertheless, simultaneous discharge of gaseous hydrogen may be desirable in order to keep the arising gas pressure in the vehicle tank as low as possible.

By means of suction removal or discharge of the gaseous hydrogen the pressure arising in the tank of the vehicle is significantly limited, which serves to improve burst protection. In addition, as a result of the integration of a discharge device the emission of hydrogen to the surroundings of the vehicle is prevented so that the danger of an explosion occurring is reduced.

One embodiment comprises a compressor that is arranged on the support device and is connected to the discharge device, and furthermore a pressure tank for receiving compressed gaseous hydrogen, which pressure tank may be connected to the compressor. The gaseous hydrogen may be received relatively simply in this pressure tank and may later be used for other purposes. With sufficient pressure in the pressure tank, for removing hydrogen it may be sufficient to open a corresponding shut-off valve.

In one of various embodiments the discharge device is connected to a catalytic burner that is adapted for combusting the gaseous hydrogen with the supply of oxidant. In one embodiment the oxidant may be ambient air. In this way it is possible, in particular in the case of larger quantities of gaseous hydrogen to be discharged, to prevent a situation in which in the surroundings of the refueling platform a potentially explosive mixture, a local reduction in the oxygen concentration during the discharge of hydrogen, or a danger of a pressure tank bursting arises.

In one embodiment the discharge device is connected to a fuel cell so that by means of the supply of gaseous hydrogen a fuel cell process may be carried out that results in generating electrical energy. In one example, the refueling platform additionally comprises an energy storage device that is adapted for receiving the arising electrical energy, which at a later stage is used, for example, for moving the refueling platform or for moving the lifting device.

One embodiment comprises a potential equalization connection that can be connected to the vehicle to be refueled. Said potential equalization connection may be designed in the form of a metallic component, for example a flange or a support frame, which may be connected to a corresponding metallic component, for example a frame or a fuselage, of the vehicle. In one example, the potential equalization connection is arranged on the base and may be connected to the vehicle to be refueled by way of an electrical line. In this manner it is possible to significantly reduce the risk of a spark arising as a result of potential difference arising during the refueling process or during the relative movement of the refueling platform on a bearing surface and the vehicle, and consequently safety of refueling is considerably improved. Affixing a corresponding metallic component on the vehicle in the region of the filler neck should be avoided so as to prevent any sparking from arising in the region of the vehicle tank during connection with the potential equalization connection.

In one exemplary embodiment, the refueling platform comprises a ground connection that may be connected to a stationary ground connection. In this manner, in addition, it is possible to prevent a potential difference between a bearing surface and the refueling platform from arising, and consequently safety is further improved by preventing ignition sparks and thus the risk of an explosion. For the sake of simplicity, the potential equalization connection and the ground connection can be combined.

In one embodiment the refueling platform comprises a drive device that is adapted for moving the refueling platform on a ground. In this manner the refueling platform may be guided to a vehicle to be refueled, for example from a workplace on the support device, and consequently very flexible refueling of larger vehicles, for example of commercial aircraft at an airport, may be carried out. Particularly suitable for this is the use of a conventional load-carrying vehicle, for example in the form of a basic truck chassis, of a platform truck, of a semi-trailer or similar, wherein the aforesaid are intended for receiving different superstructures. The design of a vehicle designed in this manner may very easily be integrated in the fleet of existing ground support vehicles of an airport, thus making it possible to refuel aircraft with liquid hydrogen without in this process interfering with established operational procedures. The base, designed as a vehicle, may thus encourage the comprehensive use of environmentally-friendly fuel cell technology, because only in this way is it possible to refuel aircraft with the required liquid hydrogen.

In one embodiment the base comprises a fastening device that is adapted for affixing the base in a stationary manner to a ground. This may, for example, be implemented by locking the chassis suspension or by extendable hydraulic supports or jacks. Stable positioning of the base on a ground improves safety during refueling, and prevents undesirable movement during the constant reduction in the weight of the refueling platform during the refueling process.

One exemplary embodiment comprises a drive startup prevention device that is adapted for making it impossible to operate a drive device of the base during a refueling process. Such a safety device may prevent damage occurring to the filler hose, or said fuel hose from being detached, from the vehicle to be refueled, when dispensing liquid hydrogen.

In addition, one embodiment comprises an emergency shutdown device that in the case of unintended movement of the refueling platform during the refueling process interrupts all the refueling functions. Even if the control system of the refueling platform were to comprise a control logic that totally prevents the movement of the refueling platform, and that in addition activates fastening devices prior to refueling, unintended movement of the refueling platform could nevertheless occur. This may, for example, happen in a collision of the refueling platform with a ground support vehicle or an aircraft so that during possibly only minor dislocation, for example of about 50 cm, the length of the filler hose may not be sufficient to compensate for the entire movement, but instead the filler hose becomes detached from the filler neck of the aircraft or becomes ruptured. It is imaginable to provide sensors in the control unit of the refueling platform, which sensors detect any acceleration of the refueling platform and by way of the emergency shutdown device as a further safety device are coupled to a trigger circuit of a shut-off valve.

In addition, one embodiment may comprise a deadman unit or person-present unit that is adapted for turning off all the refueling functions should a repeated operating signal of an operator fail to materialize. Thus in the event of an operator not being present, the safety of the entire system may be improved by this additional safety device.

In one embodiment the support device may be moved laterally. In this context the term “laterally” refers to any movement that extends parallel to the direction of extension of the support device, without influencing the height of the support device. For example, this may be implemented in the form of an extendable platform that can move in the longitudinal direction or in the transverse direction on the base. In this manner an additional reduction in the distance to a filler neck of a vehicle tank can be achieved, without positioning the base too close to the vehicle.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a diagrammatic view of a refueling platform.

FIGS. 2A and 2B show diagrammatic interconnections between components of the refueling platform.

FIG. 3 shows a diagrammatic view of a control unit.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

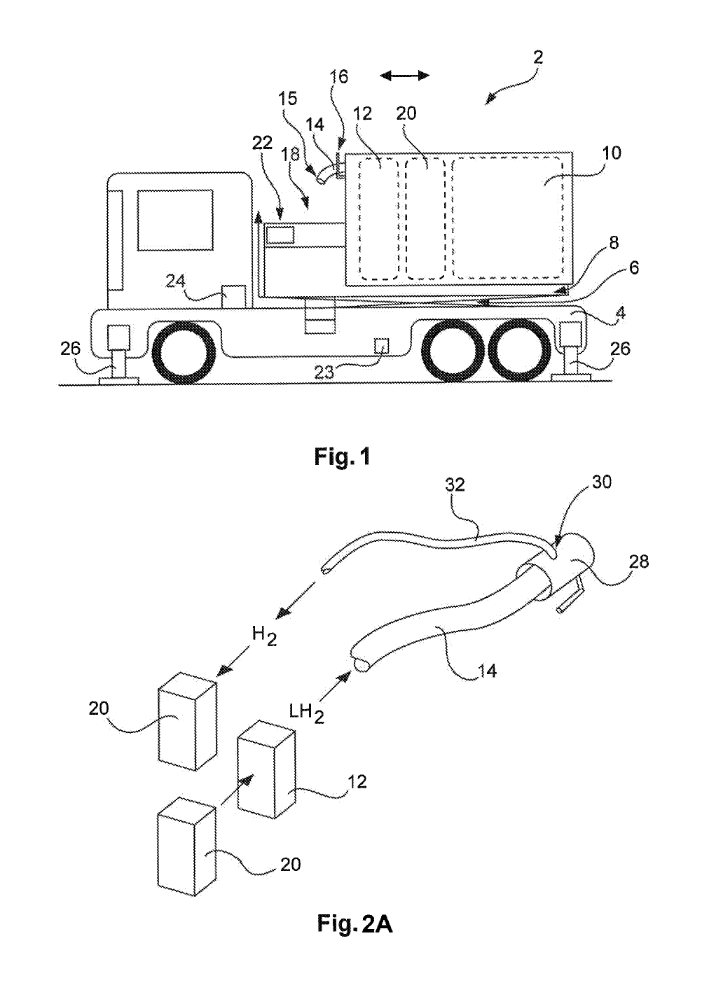

FIG. 1 shows a refueling platform 2 with a mobile base 4, a lifting device 6 arranged thereon, and a support device 8 extendable in height by way of the lifting device 6 and connected to the base 4. The support device 8 comprises a hydrogen filling tank 10 for liquid hydrogen, a conveying device 12 and a vacuum-insulated hose 14, connectable to the aforesaid, as a filler hose. The hose 14 is affixed to the refueling platform, in one example, with a holding device 16 so as not to be damaged during movement of the refueling platform 2 outside refueling processes. If the hose length is considerably longer than, for example, about 3 m or about 4 m, a drum-like fixture may suggest itself.

The lifting device 6 is adapted for clearly lifting the support device 8 relative to the base 4 so that in particular a cryogenic vehicle tank for hydrogen in an aircraft may easily be replenished from the side or from the top. In order to facilitate operation of the mobile base 2, a workplace 18 may be arranged in the support device 8, in which workplace a person may roll or unroll the vacuum-insulated hose 14 and connect it to the tank, and may operate the lifting device 6 or move the base 2.

The conveying device 12 is connected to the hydrogen tank 10 and is adapted for taking hydrogen from the hydrogen filling tank 10 and for feeding it to the hose 14. To this effect the filling station 12 may comprise pumps, valves and the like (not shown in detail) that are suitable for supplying hydrogen. As an alternative to this, the use of a pressure booster device is imaginable that increases the pressure in the hydrogen filling tank 10 so that conveyance without flow-means becomes possible.

In the region of the workplace 18 there is an operating element 22 that is, for example, connected to a control unit 24. The operating unit 22 is adapted for controlling the basic functions of the refueling platform 2. One of these functions comprises moving the support device 8 in a height direction. To this effect the lifting device 6 is, for example, also coupled to the control unit 24 and is adapted for varying the height of the support device 8 parallel to its initial position. In addition, the support device may be laterally movable in order to achieve a closer approach to a filler neck or the like when the mobile base 2 cannot be moved closer to the particular vehicle to be refueled.

The refueling platform 2 additionally comprises a fastening device with extendable supports 26 that are extended when a refueling position has been reached, thus reliably ensuring stable positioning and at the same time preventing the refueling platform 2 from rolling away.

A flange 23, which is, for example, arranged on the base 4, may be used as a potential equalization connection and/or as a ground connection. This means that the vehicle to be refueled is to be connected to the flange 23 as well as to a ground connection on the ground on which the base 4 is located. In this manner potential differences and discharge sparks are prevented.

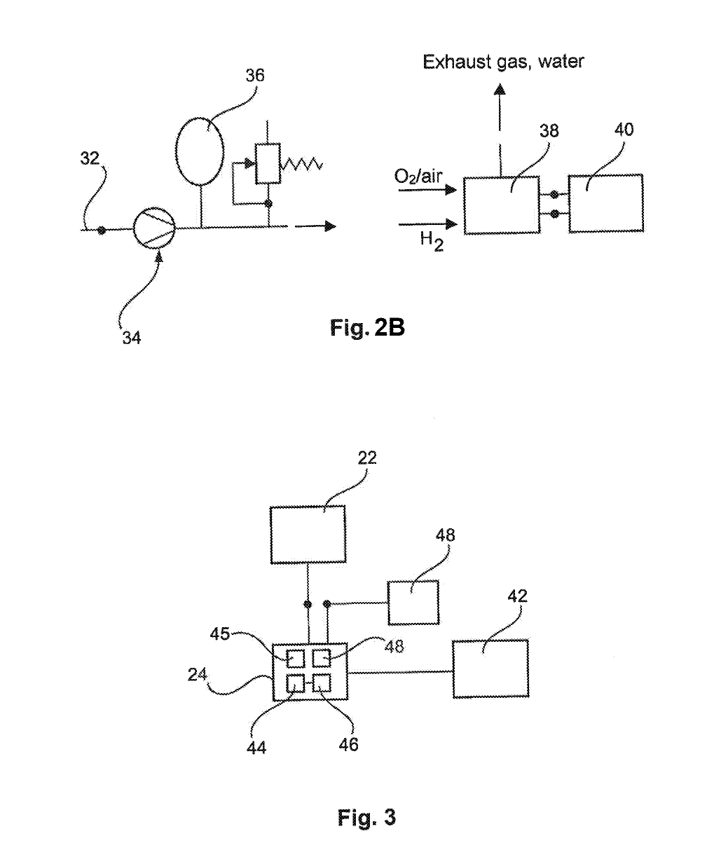

FIG. 2A shows, for example, a filler hose 14 with a coupling 28 which, for example, comprises a suction removal connection or discharge connection 30 on which a discharge line 32 is arranged. With the aforesaid it is possible when supplying liquid hydrogen (LH₂) to simultaneously discharge gaseous hydrogen (H₂) and to temporarily store it in the discharge device 20 or to further process it.

As is further shown as an example in FIG. 2B, by way of a compressor 34 the gaseous hydrogen obtained in this process may be temporarily stored in a tank 36 and supplied for further use. Such use may, for example, relate to its use in a fuel cell 38 that is coupled to an energy storage device 40 that provides electrical energy for operating the refueling platform 2. This only requires the supply of oxygen or air containing oxygen, which apart from the production of electrical energy also results in the production of air depleted of oxygen, and of water. It would also be possible, in addition, to use hydrogen from the fill tank 10 for driving the refueling platform 2 by operating the fuel cell 38 or an internal combustion engine.

Finally, FIG. 3 shows an exemplary interconnection of a control unit 24 with an operating unit 22 and with a drive device 42, which in this illustration is diagrammatically shown as a block, which drive device 42 does, however, comprise power electronics for electric motors, the control device of an internal combustion engine or further devices necessary for the refueling platform 2 to carry out movements. In order to prevent the refueling process from being continued in the case of unintentional movement, the control unit 24 generally comprises an emergency shutdown device 44, which has, for example, been implemented as a logic circuit. By way of sensors 46, which are also integrated in the control unit 24, and which may be connected to the emergency shutdown device 44, movements of the refueling platform 2 may be detected that result in immediate interruption of the refueling process, for example by the corresponding triggering of a shut-off valve.

Furthermore, a drive startup prevention device 45 is used to stop activation of the drive device 42 while the vehicle tank is being replenished. This function may be implemented as a corresponding switching logic.

In addition, the control unit 24 may comprise a so-called deadman unit 48 or person-present unit that waits for a continuous or intermittent activation signal from the operating unit 22. If this signal fails to materialize, it is also possible to achieve termination of the refueling process by the activation of a shut-off valve. Malfunction due to an operator not being present can thus to a large extent be prevented.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A refueling platform for filling a vehicle tank with liquid hydrogen, comprising:
a base,
a lifting device arranged on the base,
a support device arranged on the base, which support device is liftable by way of the lifting device,
a cryogenic hydrogen filling tank arranged on the support device, and
a conveying device,
wherein the conveying device is connectable to a filler hose that is adapted for connecting to a vehicle tank.

2. The refueling platform of claim 1, wherein the support device comprises a workplace.

3. The refueling platform of claim 1, further comprising a discharge device for the discharge of gaseous hydrogen, which discharge device is connectable to a discharge line.

4. The refueling platform of claim 3, wherein the discharge line that is connectable to the discharge device is a separate discharge line.

5. The refueling platform of claim 3, further comprising a compressor that is arranged on the support device and is connected to the discharge device, and furthermore comprising a pressure tank for receiving compressed gaseous hydrogen, with the compressor being arranged upstream of the pressure tank.

6. The refueling platform of claim 4, further comprising a catalytic burner that is connected to the discharge device and that is adapted for combusting discharged gaseous hydrogen with the supply of oxidant.

7. The refueling platform of claim 4, further comprising a fuel cell that is connected to the discharge device so that by means of the supply of gaseous hydrogen a fuel cell process is carried out that results in generating electrical energy.

8. The refueling platform of claim 1, further comprising a potential equalization connection that is connectable to the vehicle to be refueled.

9. The refueling platform of claim 1, further comprising a ground connection that is connectable to a stationary ground connection.

10. The refueling platform of claim 1, wherein the base comprises a drive device that is adapted for moving the refueling platform on a bearing surface.

11. The refueling platform of claim 1, wherein the base comprises a fastening device that is adapted for affixing the base in a stationary manner to a bearing surface.

12. The refueling platform of claim 10, further comprising a drive startup prevention device that is adapted for making it impossible to operate the drive device of the base during a refueling process.

13. The refueling platform of claim 1, further comprising an emergency shutdown device that in the case of movement of the refueling platform during the refueling process interrupts the refueling functions.

14. The refueling platform of claim 1, further comprising a deadman unit that is adapted for turning off the refueling functions should a repeated operating signal of an operator fail to materialize.

15. The refueling platform of claim 1, wherein the support device is laterally movable.
